(19) United States
(12) Patent Application Publication
(10) Pub. No.: US 2021/0378158 A1
(43) Pub. Date: Dec. 9, 2021

(54) Systems, Devices, and/or Methods for planting

(71) Applicant: Donald Adkins, Charles City, VA (US)

(72) Inventor: Donald Adkins, Charles City, VA (US)

(21) Appl. No.: 17/341,257

(22) Filed: Jun. 7, 2021

Related U.S. Application Data
(60) Provisional application No. 63/035,705, filed on Jun. 6, 2020.

(51) Int. Cl. A01B 1/10

(52) U.S. Cl. CPC A01B 1/10

(57) ABSTRACT

Certain exemplary embodiments can provide a device comprising a handle, a pair of opposing hoe retainers, a first hoe, and a second hoe. The first hoe comprises a first hoe blade. The first hoe blade is releasably coupleable to a first hoe retainer of the pair of opposing hoe retainers. The second hoe comprises a second hoe blade. The second hoe blade is releasably coupleable to a second hoe retainer of the pair of opposing hoe retainers.

### CROSS-REFERENCES TO RELATED APPLICATIONS

This application claims priority to, and incorporates by reference herein in its entirety, pending U.S. Provisional Patent Application Ser. No. 63/035,705 (Attorney Docket No. 1445-01), filed Jun. 6, 2021.

### BRIEF DESCRIPTION OF THE DRAWINGS

The patent or application file contains at least one drawing executed in color. Copies of this patent or patent application publication with color drawings will be provided by the Office upon request and payment of the necessary fee. A wide variety of potential practical and useful embodiments will be more readily understood through the following detailed description of certain exemplary embodiments, with reference to the accompanying exemplary drawings in which:

FIG. 1 is a photograph 1000 of an exemplary set of garden row hoes;

FIG. 2 is a photograph 2000 of an exemplary set of garden row hoes;

FIG. 3 is a photograph 3000 of an exemplary garden row hoe;

FIG. 4 is a photograph 4000 of an exemplary garden row hoe in use;

FIG. 5 is a photograph 5000 of an exemplary garden row hoe in use;

FIG. 6 is a photograph 6000 of an exemplary garden row hoe being adjusted; and

FIG. 7 is a photograph 7000 of an exemplary garden row hoe in use.

### DETAILED DESCRIPTION

Certain exemplary embodiments can provide a device comprising a handle, a pair of opposing hoe retainers, a first hoe, and a second hoe. The first hoe comprises a first hoe blade. The first hoe blade is releasably coupleable to a first hoe retainer of the pair of opposing hoe retainers. The second hoe comprises a second hoe blade. The second hoe blade is releasably coupleable to a second hoe retainer of the pair of opposing hoe retainers.

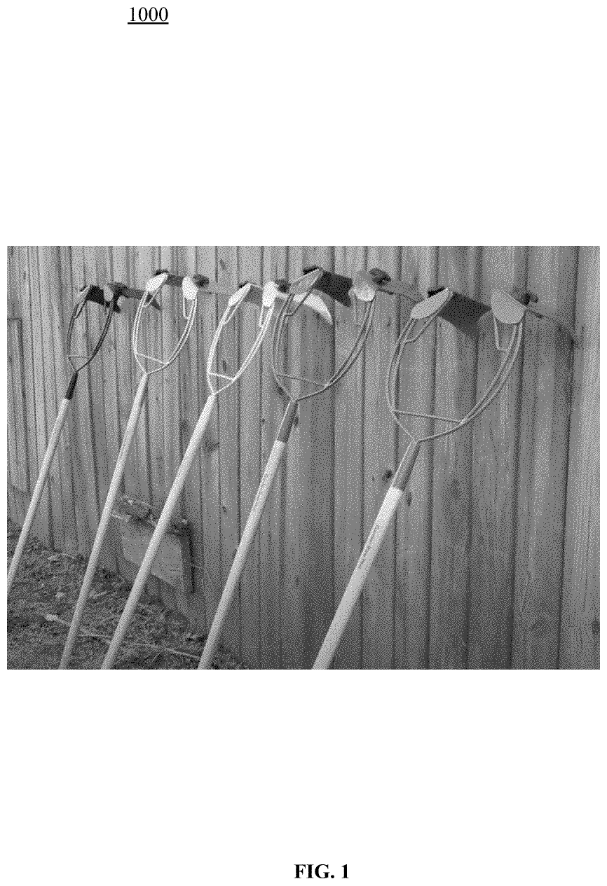

FIG. 1 is a photograph 1000 of an exemplary set of garden row hoes.

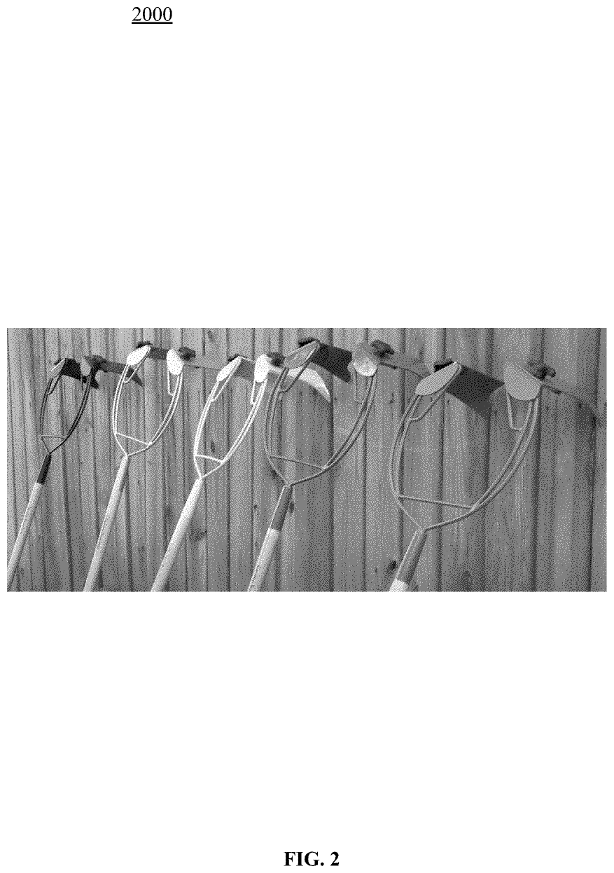

FIG. 2 is a photograph 2000 of an exemplary set of garden row hoes.

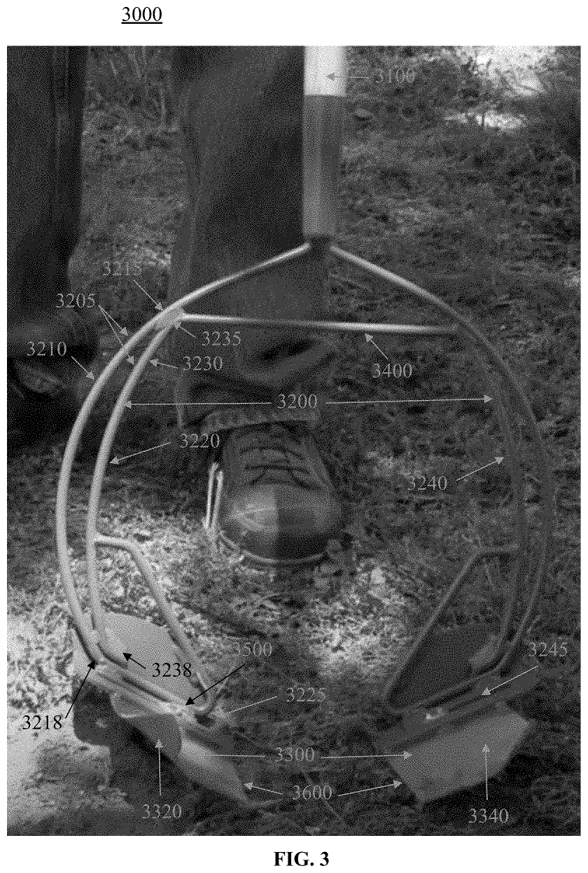

FIG. 3 is a photograph 3000 of an exemplary garden row hoe, which comprises a handle 3100, a pair of opposing hoe retainers 3200, and a pair of hoes 3300. Each of pair of hoes 3300 is releasably coupleable, and coupled, to one of pair of opposing hoe retainers 3200.

Certain exemplary embodiments comprise:
handle 3100;
pair of opposing hoe retainers 3200;
a first hoe 3320, first hoe 3320 releasably coupleable to a first hoe retainer 3220 of pair of opposing hoe retainers 3200; and
a second hoe 3340, second hoe 3340 releasably coupleable to a second hoe retainer 3240 of pair of opposing hoe retainers 3200.

When mounted, first hoe 3320 and second hoe 3340 are constructed to plow substantially parallel furrows when the device is pulled through earth via handle 3100. Pair of opposing hoe retainers 3200 is coupled via a bar 3400.

Each of pair of hoe retainers 3200 comprises a pair of curved rods 3205. A first portion 3215 of a first curved rod 3210 of pair of curved rods 3205 is fixedly coupled to a first end 3235 of a second curved rod 3230 of pair of curved rods 3205. A terminal end 3218 of first curved rod 3210 of pair of curved rods 3205 and a second end 3238 of second curved rod 3230 of pair of curved rods 3205 are each fixedly coupled to a hoe mounting flange 3225.

First hoe 3320 is coupled to first hoe retainer 3220 via a threaded fastener 3500.

First hoe 3320 is coupled to first hoe retainer 3220 via threaded fastener 3500 and hoe mounting flange 3225.

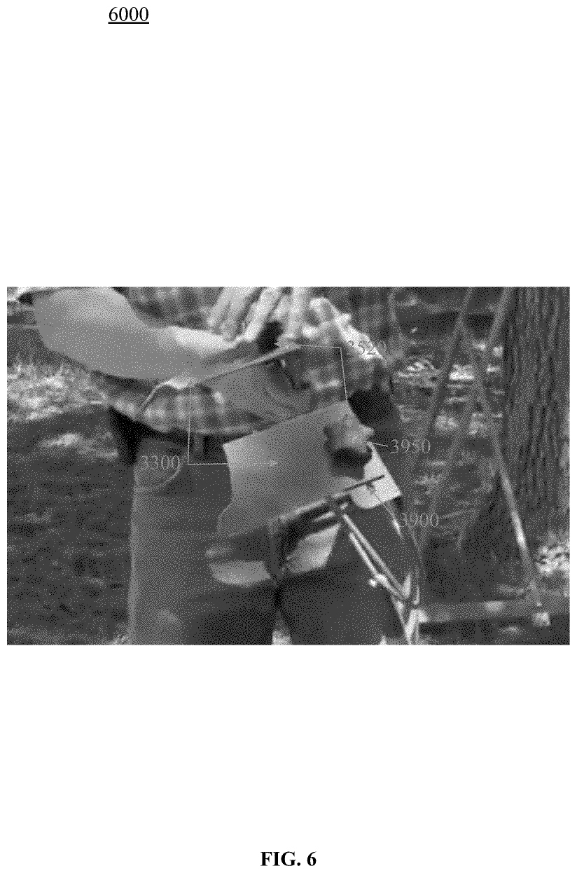

A spacing 3600 between first hoe 3320 and second hoe 3340 is adjustable via threaded fasteners 3500 in slots (see, e.g., slot 3900 of FIG. 6) defined in hoe mounting flanges 3225 and 3245.

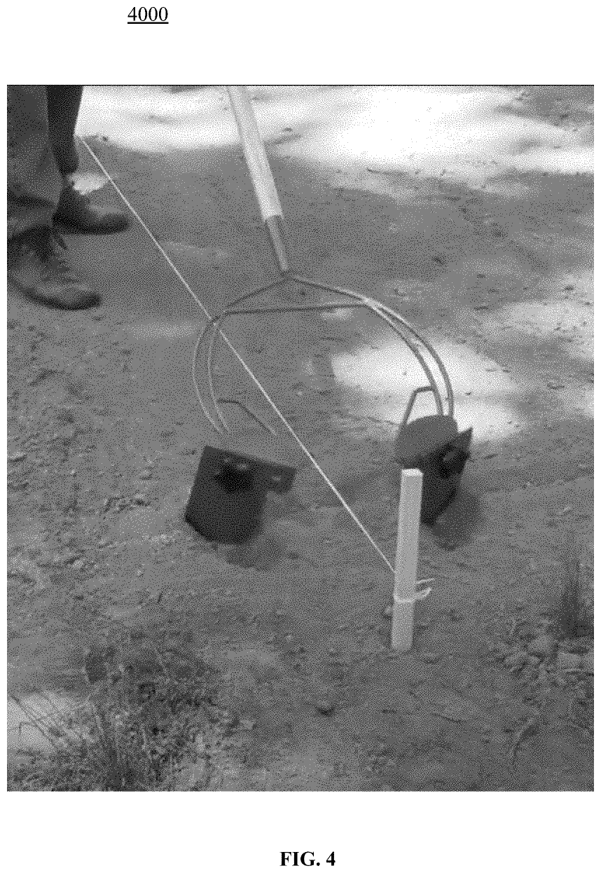

FIG. 4 is a photograph 4000 of an exemplary garden row hoe in use. Each of the pair of hoes of the illustrated garden row hoe engages with soil to form a furrow in the soil. Furrows in the soil can then be seeded with plants.

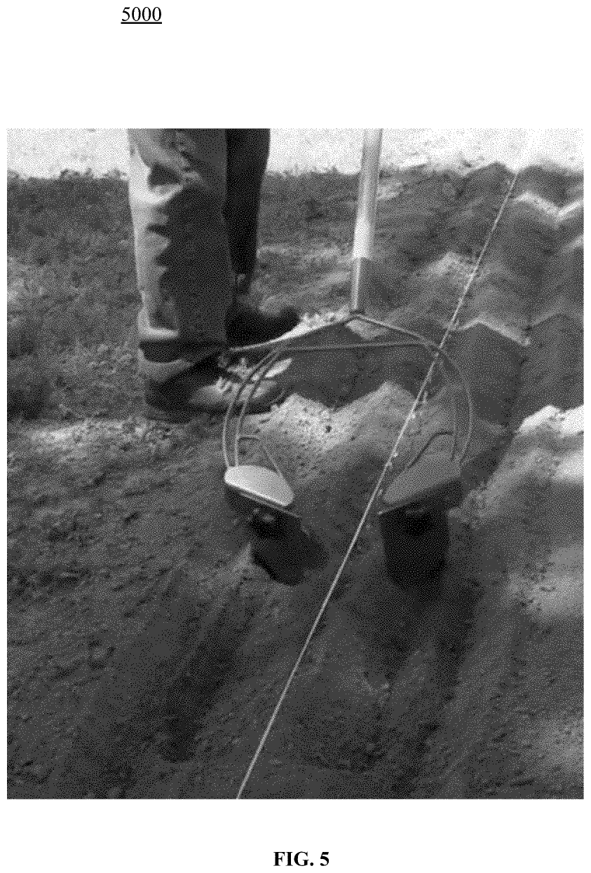

FIG. 5 is a photograph 5000 of an exemplary garden row hoe in use. As illustrated, the garden row hoe can be used to cover seeds that have been sown in furrows with soil. The garden row how allows a user to efficiently and effectively plant two furrows of seeds at a time.

FIG. 6 is a photograph 6000 of an exemplary garden row hoe being adjusted. As illustrated, pair of hoes 3300 is coupled to the garden roe hoe via a pair of fasteners 3520. The fasteners illustrated each comprise a thumb wheel 3950, which can be used to adjust a spacing of pair of hoes 3300 via a slot 3900 defined by each of pair of hoes 3300.

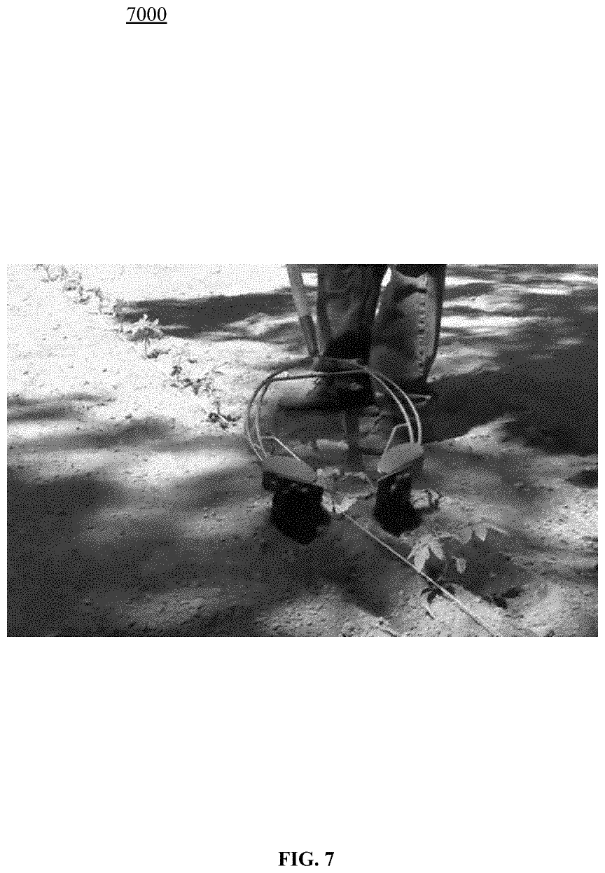

FIG. 7 is a photograph 7000 of an exemplary garden row hoe in use turning furrows adjacent to a row of plants.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
adjustable—capable of being changed to a sought position.
and/or—either in conjunction with or in alternative to.
apparatus—an appliance or device for a particular purpose.
associate—to join, connect together, and/or relate.
bar—a length of material.
blade—a cutting edge of a hoe.
can—is capable of, in at least some embodiments.
comprising—including but not limited to.
configure—to make suitable or fit for a specific use or situation.
connect—to join or fasten together.
constructed to—made to and/or designed to.
couple—to link in some fashion.
coupleable—capable of being joined, connected, and/or linked together.
curved—defined by one or more smooth rounded lines.
define—to establish the outline, form, or structure of
device—a machine, manufacture, and/or collection thereof.
fixedly—coupled so as to be firm and substantially not nondestructibly removable.
flange—a component constructed to couple another object.
furrow—a trench in the earth made by a hoe blade.
handle—a part of a thing sized and/or shaped specifically to be grasped or held by a hand of a user.
hoe—a tool comprising a blade constructed for cultivating, weeding, and/or loosening soil.
install—to connect or set in position and prepare for use.
may—is allowed and/or permitted to, in at least some embodiments.
method—a process, procedure, and/or collection of related activities for accomplishing something.
mount—to assemble.
through—moving into and out of something.
opposing—to be positioned so as to face something or be on an opposite side of something.
pair—two similar things used together.
parallel—substantially a same distance apart and generally not converging or diverging.
plow—to turn, break up, or work soil.
plurality—the state of being plural and/or more than one.
predetermined—established in advance.
provide—to furnish, supply, give, and/or make available.
pull—to exert force upon so as to tug at something.
receive—to get, take, acquire, and/or obtain.
releasably—coupled so as to be substantially nondestructibly removable.
repeatedly—again and again; repetitively.
request—to express a desire for and/or ask for.
retainer—a component that holds something in a manner that resists motion relative to the retainer.
rod—a thin bar.
set—a related plurality.
slot—a narrow opening or groove.
spacing—a distance between components.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
threaded fastener—one (or more) restraints comprising projecting helical ribs via which parts can be screwed together, which restraints attach to, extend through, penetrate, and/or hold something and engage via. For example, a threaded fastener can be one (or more) of a bolt, a bolt and nut assembly and/or a screw, etc.
through—moving in something.
transmit—to send, provide, furnish, and/or supply.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A device comprising:
a handle;
a pair of opposing hoe retainers;
a first hoe, the first hoe releasably coupleable to a first hoe retainer of the pair of opposing hoe retainers;
a second hoe, the second hoe releasably coupleable to a second hoe retainer of the pair of opposing hoe retainers; and
wherein, when mounted, the first hoe and the second hoe are constructed to plow substantially parallel furrows when the device is pulled through earth via the handle.

2. The device of claim 1, wherein:
the pair of opposing hoe retainers is coupled via a bar.

3. The device of claim 1, wherein:
each of the pair of hoe retainers comprises a pair of curved rods, wherein:
a first portion of a first curved rod of the pair of curved rods is fixedly coupled to a first end of a second curved rod of the pair of curved rods; and
a terminal end of the first curved rod of the pair of curved rods and a second end of the second curved rod of the pair of curved rods are each fixedly coupled to a hoe mounting flange.

4. The device of claim 1, wherein:
the first hoe is coupled to the first hoe retainer via a threaded fastener.

5. The device of claim 1, wherein:
the first hoe is coupled to the first hoe retainer via a threaded fastener and a hoe mounting flange.

6. The device of claim 1, wherein:
a spacing between the first hoe and the second hoe is adjustable via threaded fasteners in slotted hoe mounting flanges.
